(19) United States
(12) Patent Application Publication
(10) Pub. No.: US 2023/0186043 A1
(43) Pub. Date: Jun. 15, 2023

(54) DETERMINING COLOR RESPONSES

(71) Applicant: Hewlett-Packard Development Company, L.P., Spring, TX (US)

(72) Inventors: Josep Maria CUÑER UTGES, Sant Cugat del Valles (ES); Leyre HERNANDEZ MARTINEZ, Sant Cugat del Valles (ES)

(73) Assignee: Hewlett-Packard Development Company, L.P., Spring, TX (US)

(21) Appl. No.: 17/999,355

(22) PCT Filed: May 21, 2020
(86) PCT No.: PCT/US2020/033903

§ 371 Date: Nov. 18, 2022

(51) Int. Cl. G06K 15/02; B41J 2/045

(52) U.S. Cl. CPC G06K 15/027; B41J 2/04535

(57) ABSTRACT

In an example, a method is described. The method includes receiving a color response profile associated with a first color calibration pattern printed on a first medium. The method further includes determining a drop weight ratio associated with the first medium based on a color response profile for the first medium and a color response profile associated with a reference color calibration pattern printed on a reference medium. The method further includes determining an anticipated color response profile associated with a second medium based on the drop weight ratio associated with the first medium and a pre-determined color response profile associated with the second medium.

### BACKGROUND

Printing systems can use printheads, such as thermal inkjet printheads or piezo based printheads, to eject a print fluid, such as ink, onto a print medium to form an image. Degradation of the printheads over time or part to part variation between printheads within a printing system can cause a reduction in printed image quality due to a printed color being different to the color intended to be printed. Therefore systems may be calibrated to improve image quality by improving color reproduction.

### BRIEF DESCRIPTION OF DRAWINGS

Non-limiting examples will now be described with reference to the accompanying drawings, in which:

FIG. 1 is a flowchart of an example method of determining a color response;

FIG. 2 is a schematic drawing of an example process;

FIG. 3 is a schematic drawing of another example process;

FIGS. 4A-4D show graphs illustrating certain experimental results;

FIG. 5 is a simplified schematic drawing of an example machine-readable medium;

FIG. 6 is a simplified schematic drawing of another example machine-readable medium; and

FIG. 7 is a simplified schematic drawing of an example apparatus.

### DETAILED DESCRIPTION

Certain print systems such as thermal inkjet (TIJ) based print systems and piezo-based print systems implement color calibration to compensate for color differences between different printers (e.g., so that each printer produces printed media with a similar or same color response) and between prints produced by the printer (e.g., so that there is a consistent color response for each print).

For example, color calibration may be used in TIJ based printing systems, as TIJ printheads may degrade over their life. Such printheads may use resistors to heat a print fluid (e.g., an ‘ink’ or ‘colorant’) near a nozzle to cause a drop of print fluid to be ejected from the nozzle. Degradation may, for example, be associated with the capability of the nozzle resistor to transmit the energy to a print fluid drop to be ejected being reduced through the printhead life, which can lead to lower drop weight over the lifetime and therefore a lower colorimetric output. Color variation can also occur because of factors such as printhead manufacturing differences, media properties and different environmental conditions. Drop weight degradation and drop weight differences between printheads can account for a significant part of the color variability of a printing system.

Color calibration may be implemented by measuring color densities in a color chart printed on a medium and computing a compensation in order to obtain a specified color for subsequent prints. As the print fluid-on-media behavior (e.g., ‘dot gain’) of each medium may be different, the print fluid-color response of a determined drop weight is also different for each medium type. Thus, each medium type may have a specified color calibration in order to obtain a specified print fluid-color response at a certain time and with a certain printer.

Since different media properties (e.g., surface texture, material absorption characteristics, material color, transparency of the media, etc.) may result in a different color response for the same amount of print fluid, the amount of printed fluid delivered to a target area may be controlled according to a calibration in order to obtain the specified color response at the target area that is corrected for the media type. In other similar words, the calibration may allow a determination to be made as to how much print fluid to deliver to a target area to achieve the specified color response for different media types.

However, as mentioned above, the amount of print fluid delivered by the printhead may not be consistent for various reasons (e.g., over time and/or due to printhead manufacturing differences) and therefore the calibration may be repeated over time and/or at the time of printhead replacement, inspection or servicing to ensure that the specified color response is still obtained. Such a calibration may indicate that a change is needed in terms of the amount of print fluid output by the printhead in response to a print instruction.

In some examples, the number of print fluid drops delivered to a target area may be controlled based on the calibration. For example, the calibration may indicate that a different number of print fluid drops are needed to achieve the specified color response in the target area compared with what is indicated by a previous print instruction. This number of print fluid drops for achieving the specified color response may also be referred to as a ‘drop count ratio’ (DCR). The DCR may be defined as the ratio of drops (e.g., relative to a reference drop count) that the printer system needs to fire to compensate or correct for a color difference (relative to the specified color response) obtained for a specified medium.

In some examples, the calibration may indicate that a different print fluid drop size (e.g., drop weight or drop volume) is needed to achieve the specified color response in the target area compared with what is indicated by a previous print instruction. The print fluid drop size for achieving the specified color response may also be referred to as a ‘drop weight ratio’ (DWR). The DWR may be defined as a ratio of drop weight (e.g., relative to a reference drop weight) to compensate or correct for a color difference (relative to the specified color response) obtained for a specified medium.

Thus, a print instruction may be updated to take the DCR and/or DWR into account for a color calibrated print operation. In other similar words, the updated print instruction may cause the printhead to deliver a different number of print fluid drops to the target area and/or a different print fluid drop size to the target area to achieve a calibrated color response for a print operation.

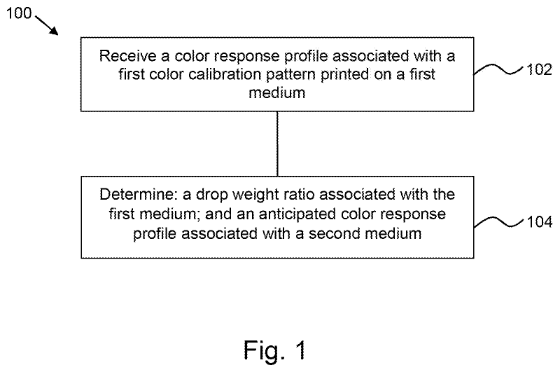

FIG. 1 shows an example of a method 100 (e.g., a computer-implemented method) of determining a color response (e.g., an anticipated color response when printing on a medium). The determined color response may be used to calibrate a printer or printhead such that the amount of print fluid delivered by the printhead to a target area on a medium yields a specified color response at a target area.

The details of the blocks of the method 100 are described below.

The method 100 comprises, at block 102, receiving a color response profile associated with a first color calibration pattern printed on a first medium.

The color response profile may correspond to a print fluid-color (e.g., an ‘ink-color’) response obtained by measuring the color density of the first color calibration pattern (e.g., ‘color chart’) printed on the first medium. In some examples, a sensor used to measure the color density may be a spectrophotometer or a light source with a corresponding photodiode to detect the reflected or transmitted light levels from the printed medium and/or may be provided as part of an ‘in-line’ scanner apparatus past which the printed medium is passed as part of a calibration operation.

In some examples, the first color calibration pattern may be obtained at an appropriate time (e.g., after a specified time interval and/or after a printhead replacement, inspection or service) by printing the first calibration pattern on the first medium with a printer and then measuring the first color calibration pattern as printed on first medium with the sensor to obtain print fluid-color response data, which can be used to determine the color response profile.

In some examples of block 102, the color response profile may be received from the sensor and/or from a memory storing data indicative of the color response profile. In some examples, the received color response profile may comprise data values from the sensor measurement which link the amount of print fluid delivered to a particular target area with the measured color response (or color density) at that target area. The color response profile may refer to the measured color response at a plurality of target areas on the (first) medium where the amount of print fluid delivered to each target area is different (e.g., based on a scale of increasing or decreasing print fluid delivered to each subsequent target area).

The method 100 further comprises, at block 104, determining (e.g., using processing circuitry e.g., of a user computer or a cloud or server-based service) a drop weight ratio associated with the first medium based on a color response profile for the first medium and a color response profile associated with a reference color calibration pattern printed on a reference medium.

As mentioned previously, the drop weight ratio (DWR) may refer to the print fluid drop weight relative to a reference print fluid drop weight to achieve a specified color response. For example, the specified color response may correspond to the color response obtained by printing on the reference medium with a certain print fluid drop weight. Rather than specifying the exact drop weight (e.g., in terms of milligrams or whichever weight measure is appropriate), in some examples, the DWR may be set to equal ‘1’ (one) for the reference medium. In some examples, determining the DWR associated with the first medium may comprise determining the current DWR for a print element (e.g., a ‘printhead’) of the printer relative to the DWR as obtained for the reference medium (e.g., where the DWR equals 1).

In some examples, determining the current DWR for the first medium may involve comparing the color response profile for the first medium with a previously-obtained color response profile for the first medium to determine the change in the DWR. Since a change in the color response profile for the first medium over time may correspond to a change in the DWR for the first medium over time, it is possible to determine the change in the performance of the print element. This determination of the DWR (of the first medium) may be linked to the color response profile associated with the reference color calibration pattern printed on the reference medium (as obtained previously). In other similar words, since the color response profile associated with the first medium may have changed by a certain amount (and this may be reflected in terms of a change in the DWR for the first medium), we may also expect that the color response profile (and hence the DWR) for the reference medium may also have changed by a corresponding amount.

The method 100 further comprises, at the block 104, determining (e.g., using processing circuitry e.g., of a user computer or a cloud or server-based service) an anticipated color response profile associated with a second medium based on the drop weight ratio associated with the first medium and a pre-determined color response profile associated with the second medium.

As highlighted above, by comparing the ‘current’ DWR of the first medium with the color response profile associated with the reference color calibration pattern, it is possible to predict how the current DWR may affect the color response on any other pre-characterized media. For example, if the DWR has changed by a certain amount, this information can be used to anticipate the color response profile for the second medium (e.g., providing the second medium is also linked to the reference medium).

The anticipated color response profile associated with the second medium may, in some examples, refer to a ‘simulated’ color response profile for the second medium.

In some examples, since there is a link between the color response for the first medium relative to the reference medium as well as a link between the color response for the second medium relative to the reference medium, it may be possible to predict what the color response is anticipated to be for the second medium without (again) measuring the color response of the second medium. In other similar words, the color response associated with the second medium may have been obtained previously at the same time as obtaining the color response associated with the reference medium at a certain DWR (i.e., the same DWR for both the reference and second medium).

In some examples, by establishing the current DWR for the first medium (which is linked to the second medium via the reference medium), it may be possible to anticipate the color response at the current DWR for printing on the second medium.

In some examples, an ecosystem with multiple different media which have previously been characterized, it may be possible to work out the color response for each of these different media by simply performing a measurement using one of the media of the ecosystem. This may avoid the need to perform calibration measurements for each of the media each time a color calibration is to be undertaken. This may save significant time and effort for the end user.

In some examples, the ecosystem provided by certain methods described herein may link the different media so that a common calibration can be performed across all the different media. This common calibration may be based on establishing common color references based on nominal relative drop weight without needing to perform a color measurement each time the printer needs to be calibrated.

In some examples, certain methods described herein may facilitate an ecosystem comprising different media which can be characterized and cross-calibrated to allow a universal color calibration. Different types of media may have different color responses. However, the approach of certain methods described herein may allow calibration of various different types of media such as backlit, textiles and texturized media. Thus, irrespective of the type of media, a user may find it relatively simple and less time consuming to calibrate every type of media in an ecosystem by performing a calibration as appropriate for a certain media and, by extension, this calibration can be applied to all of the different media in the ecosystem.

In some examples, the ecosystem may allow the same color response to be achieved among a population of printers without the connecting the printers. This may take into account differences in terms of how each of the printers perform and/or timing differences in terms of when printheads are replaced, inspected or serviced. For example, by printing a color calibration pattern on the same type of reference medium using each of the printers, it may be possible to link the performance of each of the printers (e.g., by determining the DWR for each printer that yields the same color response for the reference medium) such that any other medium characterized as part of the ecosystem can be printed on by any of the printers with the specified color response.

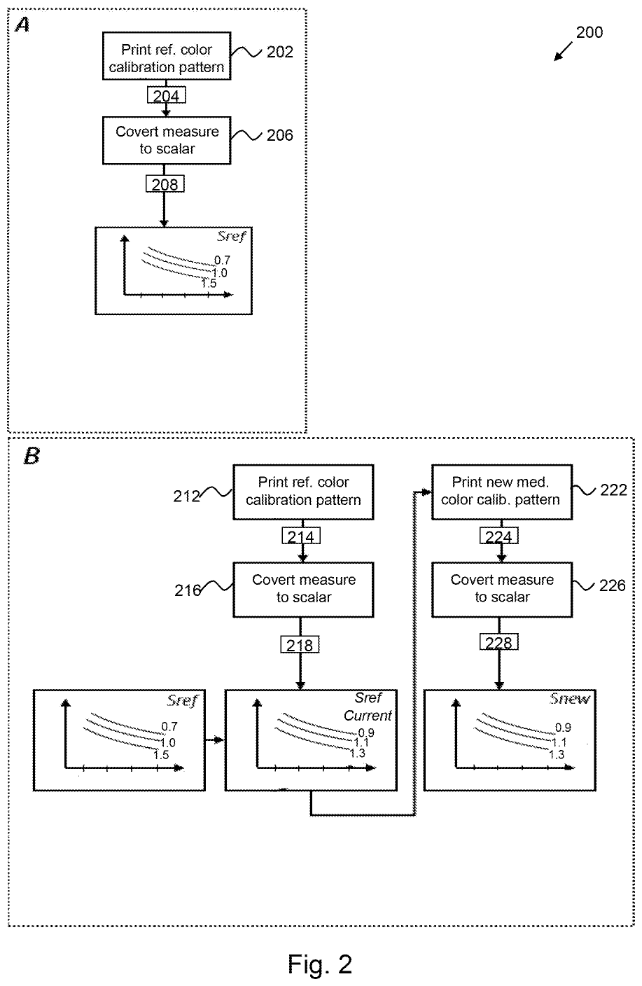

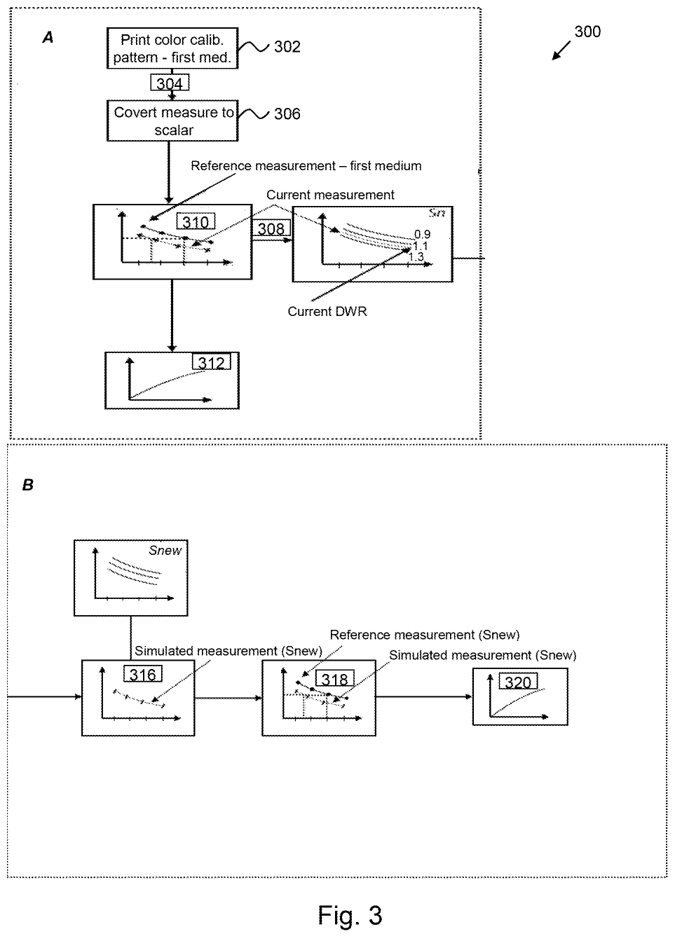

As discussed above, the method 100 may be implemented by a user. However, the method 100 describes part of how the ecosystem is set up and/or used. In this regard, the ecosystem may comprise various processes which may be implemented by a printer manufacturer (e.g., to create the ecosystem) and/or by an end user (e.g., which may use the ecosystem and/or contribute the ecosystem). The ecosystem is therefore described in more detail below with reference to FIGS. 2 and 3.

FIG. 2 depicts the process of creation of an ecosystem 200 (e.g., by a printer manufacturer) which may be used for facilitating implementation of certain methods described herein. For example, the ecosystem 200 described with reference to FIG. 2 may be used by an end user to perform a color calibration operation (e.g., as implemented by the method 100 of FIG. 1), which is described in more detail with reference to FIG. 3.

Certain blocks of FIGS. 2 and 3 may be implemented as part of certain methods (e.g., method 100) or processes, machine-readable media and/or apparatus described herein. For example, certain blocks may refer to part of a process (e.g., a method, which may be implemented as part of or in conjunction with the method 100).

FIG. 2 therefore describes how different media are characterized as part of creation of the ecosystem 200. These media may then be regarded as cross-calibrated across the ecosystem. This process of creating the ecosystem 200 comprises two parts in this example: part ‘A’ and part ‘B’ (as labeled in FIG. 2). In some examples, part ‘A’ may be implemented by a printer manufacturer (e.g., to create a trusted or universal ecosystem). In some examples, part ‘B’ may be implemented by the printer manufacturer and/or an end user.

Part A refers to the characterization of a (master) reference medium. The reference medium may comprise a medium such a coated paper, a printable ceramic or other appropriate medium.

A printer is caused to print, at block 202, a ‘reference color calibration pattern’ on the reference medium with different print fluid drop weights (as will be described in more detail below).

In some examples controlling a drop size comprises modifying instructions which determine the energy delivered to a printhead when ejecting a print fluid drop. Drop size, also referred to as drop weight or drop volume, may be controlled to vary the printed output. Drop size can be varied by adjusting the energy delivered to a printhead. In some examples, for example in piezo or TIJ based printheads, the drop size may be varied by applying a different voltage to the printhead to alter the energy delivered. In other examples, for example in a TIJ based printhead, the drop size can be varied by changing the duration of a voltage pulse applied to the printhead, which is also referred to as pulse width modulation. Therefore in some examples increasing or decreasing the energy is achieved by modifying control instructions to increase or decrease a time period for which a voltage is applied to a printhead, and determining the second control instructions may comprise determining a time period for which a voltage is applied. This may comprise modifying a previous or default time period.

In some examples, dot density refers to the number of dots of print fluid printed on a print media per unit area. For example dot density may be measured in dots per inch (dpi) or dots per centimeter (dpcm) which is a count of the number of dots along a line of length one inch, or one centimeter respectively.

In some examples, a printhead may move relative to a surface of a print medium which is being printed on, for example the printhead may be mounted on a movable carriage or the print media may be moved by a print transport mechanism past the printhead. Therefore, the dot density can be controlled by varying the firing frequency of a printhead. In some examples, instructions to modify the printing instructions to increase or decrease the print fluid dot density comprise modifying the instructions to increase or decrease the rate at which ink drops are ejected from a printhead. For example if a printhead fires drops of ink at a higher rate, the print media will have more dots per unit area, whereas if the printhead fires drops of ink at a lower rate the print media will have fewer dots per unit area.

As mentioned above, the color calibration pattern may be printed at different print fluid drop weights. For example, if two different print fluid drop weights are used, two color calibration patterns may be the print output.

Thus, in some examples, the color response profile associated with the reference medium comprises at least two color response profiles. Each color response profile may correspond to a different relative drop weight ratio for a print fluid printed on the reference medium. In the example depicted by FIG. 2, three color response profiles are determined for three corresponding drop weights.

In some examples, the different relative drop weight ratio is obtained by changing a parameter for controlling a weight of the print fluid output by a print element.

At block 204, the colorimetric response (e.g., the ‘print fluid-color response’ or ‘color density’) of the color calibration pattern(s) printed on the reference medium is measured using a sensor.

In some examples, the measured aspect of a printed output may be a measure of the quantity of a print fluid, such as ink, which is ejected from the printhead on to a print medium (i.e., the reference medium). The measurement may for example comprise measurement of a coverage value, which is the proportion of a region of the print media which is covered with print fluid and may be expressed as a ratio or percentage of the region which is covered with print fluid to the total area of the region (area covered with print fluid plus the area not covered with print fluid). A higher coverage value, or printed coverage, appears as a more saturated color, whereas a lower printed output results in a less saturated color and appears more similar in color to the print media. For example if black ink is printed by a printhead on white paper at 20%, the color of the printed region appears a light grey, at a higher coverage, such as 70%, the color of the printed region appears a darker grey and at 100% coverage the printed region appears black. Therefore, saturation may be measure of the quantity (e.g., number of drops) of a print fluid which has been ejected by the printhead.

At block 206, the measurements are converted to a (scalar) value of colorimetric magnitude, wherein the colorimetric value may be a measure in L*, a*, b*, a measure of Chroma, a measure of optical density, or a combination thereof. The colorimetric magnitude may be a measure of light reflected by the media or may be a measure of such reflected light converted into a color space, for example L* a* b* or any other suitable color space. The measure of colorimetric values may generally provide a measure of saturation and/or print fluid quantity. In some examples, the measure of colorimetric values refers to the ‘color response’ or ‘color response profile’ described herein.

At block 208, the color response profile for each of the different drop weights may be visually compared by representing this data on a graph. Also at block 208, this data may be stored on a memory (e.g., on a terminal for use by an end user, a server or a cloud-based service). This data corresponds to the color response profile associated with the reference color calibration pattern printed on the reference medium (as referred to in block 104 of the method 100).

As mentioned above, the color response profile is obtained for different print fluid drop weights. In some examples, the different drop weights may be obtained by utilizing different resistor energies within the printhead nozzle to cause a different weight of print fluid to be ejected by the nozzle. The absolute value of the print fluid drop weight need not be determined. Instead, the relative value of the print fluid drop weight is of interest. For example, by using certain resistor energies (these values being recorded for future use), it can be anticipated that a certain color response profile may be obtained for each resistor energy used due to the change in print fluid drop weight. Thus, a first resistor energy is used to obtain a first color response profile and a second, different, resistor energy is used to obtain a second color response profile. Each color response profile is obtained by changing the density of the print fluid printed on the reference medium (e.g., by firing a different number of print fluid drops at each target area). Further color response profiles (e.g., three or more) may be obtained with further different resistor energies.

In the example graph labeled ‘Sref’ in part A of FIG. 2, three different resistor energies are used to obtain three color response profiles at three different drop weights. The x-axis of the graph represents how much print fluid is delivered to the medium (e.g., a number of print fluid drops delivered to a target area of the medium). The y-axis of the graph represents a color density (i.e., a scalar value) of the print fluid on the reference medium for the corresponding x-axis value. Since the resistor energies are established (and recorded), the absolute values of the print fluid drop weights do not need to be calculated. Instead, the relative difference between the resistor energies may be determined relative to a ‘reference’ DWR of 1 for a ‘reference’ resistor energy. The line labeled ‘1.0’ in the graph corresponds to DWR=1.0.

In an example, if a resistor energy of 70% (relative to the reference resistor energy) is used to print a color calibration pattern on the reference medium, the color response profile obtained when printing with a resistor energy of 70% is shifted relative to the reference DWR. The line labeled ‘0.7’ in the graph corresponds to DWR=0.7. The decrease in the resistor energy compared with DWR=1.0 decreases the amount, or weight, of each print fluid drop delivered by a print element. The color density obtained for a given number of print fluid drops delivered (e.g., an x-axis value) is different for DWR=1.0 and DWR=0.7 (i.e., the color density is reduced for DWR=0.7 because less print fluid is delivered with each print fluid drop when the resistor energy used is reduced). Note that the y-axis on the graph is inverted such that a lower position in ‘y’ corresponds to a larger density.

In another example, if a resistor energy of 150% (relative to the reference resistor energy) is used to print another color calibration pattern on the reference medium, the color response profile when printing with a resistor energy of 150% is shifted relative to the reference DWR. The line labeled ‘1.5’ in the graph corresponds to DWR=1.5. In contrast to the case where DWR=0.7, the increase in the resistor energy compared with DWR=1.0 increases the amount, or weight, of each print fluid drop delivered by a print element. Thus, the color density obtained for a given number of print fluid drops delivered is different for DWR=1.0 and DWR=1.5 (i.e., it is increased for DWR=0.7 because more print fluid is delivered with each print fluid drop when the resistor energy used is increased).

The different color response profiles obtained at the different print fluid DWRs for the reference medium may be referred to as a pre-determined color response profile associated with the reference medium.

Part B of implementing the ecosystem 200 describes the process to introduce a new medium to the cross-calibrated ecosystem 200. In some examples, the same procedure described in part A is repeated (i.e., block 212 corresponds to block 202; block 214 corresponds to block 204; block 216 corresponds to block 206 and block 218 corresponds to block 208). The purpose of repeating part A is to verify whether or not there has been any change to the DWR for the reference medium (i.e., by comparing the graph generated after block 218 (i.e., ‘Sref Current’)) with the graph generated after block 208 (i.e., ‘Sref’)). In depicted example, the DWR has changed for the three different energies. The original measurement from part A indicated DWR=0.7, 1.0 and 1.5 for the graph labeled ‘Sref’ in FIG. 2. However, the new color response profile measurements for ‘Sref Current’ indicates that the DWR has changed from the original measurement based on the observed color response profiles for the same energy as applied in the original measurement. In this example, the new DWRs that achieve the three color response profiles are determined to be DWR=0.9, DWR=1.1 and DWR=1.3.

If there has been a change to the DWR, the newer color response profile associated with the reference medium may be saved in a memory for future use. Thus, in some examples, part A may not be repeated in part B (e.g., if not much time has elapsed since implementing part A). The graph generated after block 218 (i.e., ‘Sref current’) therefore corresponds to the ‘current’ color response profile associated with the reference medium and may be indicative of the ‘current DWR’ for the reference medium.

Then, a new medium (e.g., a ‘first medium’ or a ‘second medium’ as referred to in the method 100) is introduced to the ecosystem 200. The same procedure as used in blocks 212 to 218 is used to generate the color response profile for the new medium (i.e., blocks 222 to 228, respectively). That is, the same resistor energies are used to deliver the same relative print fluid drop weights to the new medium as used when printing on the reference medium. The potentially different color response observed on the new medium may be used to calibrate the amount of print fluid needed to obtain the specified color response (i.e., the same color response for the new medium as for the reference medium). The different color response profiles obtained at the different print fluid DWRs for the new medium may be referred to as a pre-determined color response profile associated with the new medium (or ‘first’ or ‘second’ medium).

In some examples, the pre-determined color response profile associated with the first and/or second medium is obtained by printing with the same relative drop weight ratios used to obtain the color response profile associated with the reference medium.

In some examples, part B of FIG. 2 may be implemented by an end user (e.g., a customer that uses a printer) when the user wants to add a new medium to the ecosystem 200. In some examples, part B of FIG. 2 may be implemented during printer development (e.g., by a printer manufacturer) to characterize other media apart from the reference medium.

In summary, FIG. 2 refers to the creation of an ecosystem 200 where multiple different media can be added to the cross-calibratable ecosystem 200. Each medium is linked to the other media in the ecosystem 200 via the reference medium since, in this example, the same resistor energies are used to cause the firing of the print fluid drops when printing the color calibration patterns on the different media. In some examples, this process in FIG. 2 may be performed once during printer development and/or when adding new media to the ecosystem 200 and may not need to be repeated (e.g., to save time and/or costs).

FIG. 3 refers to a process 300 used by an end user to perform a color calibration operation (e.g., part of which has been described with reference to the method 100 of FIG. 1).

The process 300 comprises two parts: part A and part B. In part A, the user performs a measurement in order to determine a universal calibration to be calculated for the printer. In part B, the universal calibration determined by part A of process 300 is used to determine a calibration which applies to all of the media in the ecosystem 200. By performing, for example, one measurement in part A, the whole ecosystem 200 (described in relation to FIG. 2) can be cross-calibrated so that when printing with any of the different media types in the ecosystem 200, the color response is the same or at least corresponds to the specified color response. In this manner, in some examples, a user may not need to repeat the calibration for each of the media types e.g., to save time and/or costs. Since, in some examples, the calibration may be performed at various time intervals during operation of the printer, this time and/or cost saving measure may be accumulated as time goes on. Further, in some examples, the user may find that the color response is consistent across different media types.

In part A of the process 300, a measurement is performed on any medium (e.g., a ‘first medium’) in the ecosystem 200. The process 300 involves a similar implementation to that described in relation to FIG. 2. In this regard, blocks 302 to 308 of process 300 correspond to implementing the functionality of e.g., blocks 212 to 218, respectively but for the first medium.

In some examples, the process 300 comprises causing a print element to print the first color calibration pattern on the first medium, which may correspond to block 302 of the process 300.

In some examples, the process 300 comprises causing a measurement device (e.g., a ‘sensor’) to obtain an indication of the color response profile associated with the first color calibration pattern printed on the first medium, which may correspond to block 304 of the process 300. This indication may be converted to the color response profile (e.g., at block 306 of the process 300).

The graph shown after block 306 depicts computation, at block 310, of a drop compensation ratio (DCR) to be used for compensating for the color response on the first medium (e.g., as a result of printhead degradation over time and/or manufacturing differences). The DCR is calculated by comparing the ‘current measurement’ (indicated by the arrow in FIG. 3) of the color response profile of the ‘first’ color calibration pattern printed on the first medium with a ‘reference measurement—first medium’ (e.g., a reference measurement of the color response profile of the ‘first’ color calibration pattern printed on the first medium as obtained during creation of the ecosystem 200). The DCR for the first medium is used to compute, at block 312, a calibration (or ‘compensation’) to be applied for adjusting the number of print fluid drops to fire in order to obtain the specified color response for the first medium. This is represented by the graph comprising block 312, which indicates how much print fluid (e.g., ink) is needed (x-axis) in order to obtain a certain color density (y-axis) on the first medium. Whenever a new measurement is performed using the first medium (i.e., via blocks 302 to 306), the calibration may, if needed, be updated to ensure continued color response consistency when printing on the first medium.

The graph shown after block 308 corresponds to the color response profile for the reference medium (i.e., the pre-determined color response profile for the reference medium) as referred to in FIG. 2. The color response profile associated with the ‘current DWR’ (i.e., the ‘current measurement’ in FIG. 3, as determined by measuring the first medium) is shown in the graph to show the relationship between the current DWR and the color response profile at the different DWRs used to generate the graph corresponding to predetermined color response profile for the reference medium. By comparing the color response profiles (of the first medium and the reference medium), it may be possible to determine the DWR for the first medium needed to obtain the specified color response (e.g., as may be indicated by the color response profile for the reference medium).

In some examples, receiving the color response profile associated with the first color calibration pattern printed on the first medium, as referred to in block 102 of the method 100, may correspond to receiving (e.g., from a sensor or a memory) the ‘current measurement’ of the color response profile of the first medium as shown by FIG. 3.

In some examples, determining the DWR associated with the first medium, as referred to in block 104 of the method 100, may correspond to comparing the color response profiles as shown in part A of the process 300 in FIG. 3.

In some examples, as part of block 308, a comparison may be made between the color response profile associated with the first medium and the pre-determined color response profile associated with the reference medium. This comparison may be used to update a memory such as a look-up table (LUT) indicating the current DWR for the first medium. Thus, in some examples, the process 300 comprises using a comparison of the color response profile associated with the first color calibration pattern printed on the first medium and the color response profile associated with the reference color calibration pattern printed on the reference medium to update a memory indicating a drop weight ratio to use for printing on each of a plurality of media to calibrate the color response profile of each of the plurality of media.

In part B of the process 300, the information obtained by performing the measurement in part A of the process 300 may be used to cross-calibrate all of the different media in the ecosystem 200 to ensure that the specified color response is obtained irrespective of the type of media being printed on at that time. In part B, the procedure for cross-calibrating the rest of the ecosystem 200 is described with reference to the calibration obtained for the ‘second medium’. In some examples, the procedure is similar to part A of process 300.

At block 316 of the process 300, an anticipated (or simulated) color response profile associated with a second medium (see ‘Simulated measurement (Snew)’ in FIG. 3) is determined based on the DWR associated with the first medium and a pre-determined color response profile (see graph labeled ‘Snew’) associated with the second medium (e.g., as determined when creating the ecosystem 200). In some examples, block 314 corresponds to part of block 104 of the method 100.

Once the anticipated color response profile is determined, this can be used to compute, at block 318, the DCR for the second medium based on the reference measurement for the second medium (i.e., ‘Reference measurement (Snew)’ in FIG. 3) in a similar manner to that described in relation to block 310 of the process 300.

In the same manner as block 312 of the process 300, the DCR for the second medium is used to compute, at block 320, a calibration (e.g., a ‘compensation’) to be applied for adjusting the number of print fluid drops to fire in order to obtain the specified color response for the second medium.

In some examples, which may correspond to block 320, determining a compensation to apply to a print element to obtain a specified color response profile for printing on the second medium is based on a comparison of the anticipated color response profile associated with the second medium and the pre-determined color response profile associated with the second medium.

In some examples, the compensation comprises a print fluid drop count ratio for the print element (e.g., as obtained at block 318) to deliver to correct for a color response of the second medium at a given number of print fluid drops to obtain the specified color response profile.

The process 300 in part B of FIG. 3 may be implemented, in some examples, for each medium in the ecosystem 200 to cross-calibrate across the whole ecosystem 200. Thus, a single measurement is taken in part A of the process 300 but this can be cross-referenced to the entire ecosystem 200 via the reference medium to avoid having to take multiple calibration measurements for each medium, which may save time and/or costs.

In an experimental run to verify the effectiveness of the calibration procedure described herein, a cross-calibration ecosystem such as described above was generated. The measurements performed in this experimental run demonstrated that an acceptable calibrated color response can be obtained when printing on different media types using certain methods, machine-readable media and/or apparatus described herein.

In this example, the results were obtained using a HP Latex 570 Series printer system (using Latex Gen 3 inks and HP 831 Printheads) calibrating on Orajet 3551 Self Adhesive (e.g., corresponding to the ‘reference medium’ describe above) and cross calibrating a backlit substrate (e.g., corresponding to the ‘first’ or ‘second’ medium described above).

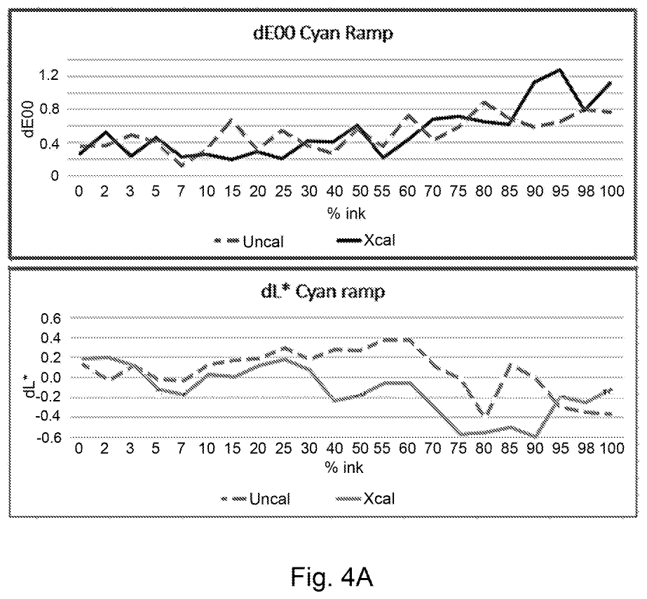

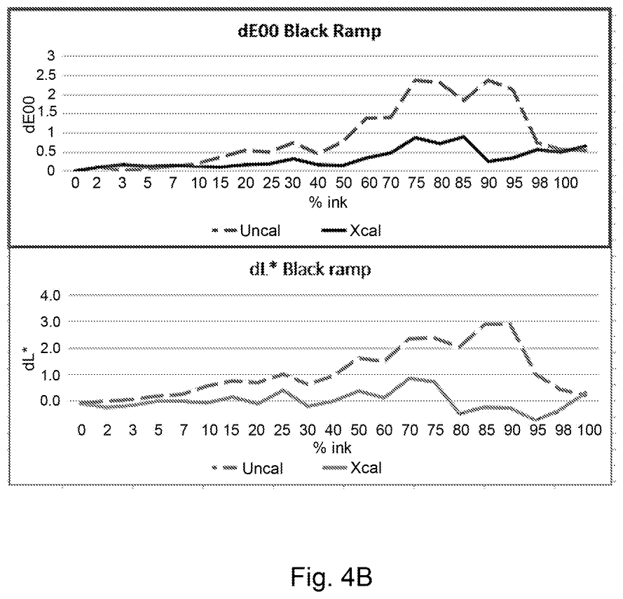

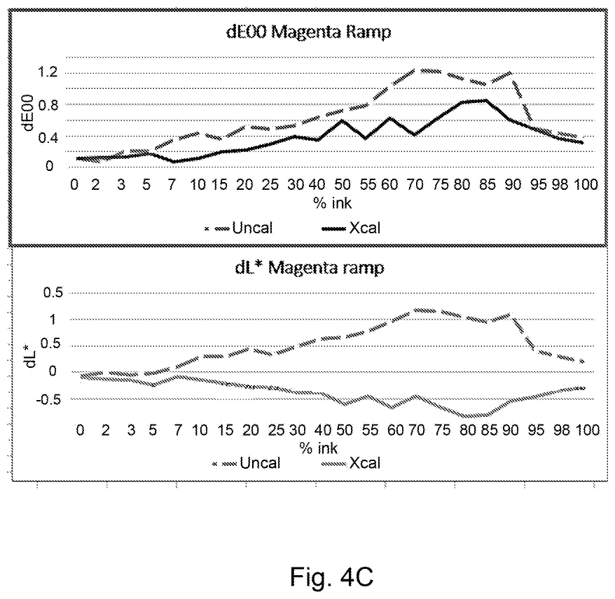

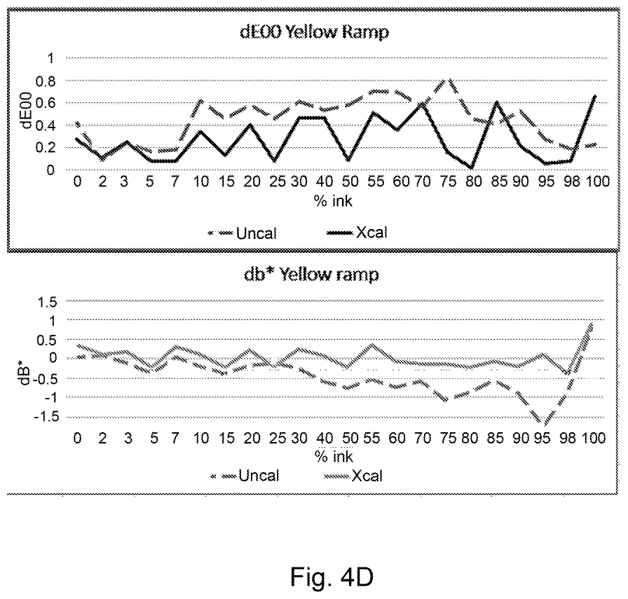

FIGS. 4A-4D show the color difference in DE00 and dL*/b* along the color ramps as obtained from the experimental run for each of the different ink colors (i.e., cyan in FIG. 4A, black in FIG. 4B, magenta in FIG. 4C and yellow in FIG. 4D). As can be seen from the graphs, the colors that have been cross-calibrated provide better consistency (i.e., less deviation from an expected color density for a range of different ink percentage levels—or ‘color ramp’) after calibration (see lines labeled ‘Xcal’) compared to before performing the calibration (see dashed lines labeled ‘Uncal’). The cross-calibration results were found to be particular effective in the cases where the color consistency across the color ramp was found to be bad before performing the calibration.

In some examples, the proposed ecosystem described above is based on the characterization of a (master) reference medium. The characterization comprises storing a print fluid (i.e., ink) versus color response (e.g., color density, L* or b*) curves at different relative drop weights. Then, by means of printing with this reference medium every time a new substrate (e.g., a first or second medium) is added to the ecosystem (but just for the first time) a characterization is built and stored for this new substrate without the need to measure drop weight as it is linked to the drop weights used for the reference medium. The variables that may be used to modify the print fluid drop weight may vary the resistor energy (e.g., by modifying, voltage, pulse width or thermal settings of the printhead). The modification of these variables may not be regarded as a solution for a regular calibration due to the trade-offs in printhead reliability (in the long term) but may be appropriate for a short-term solution to cross-media characterization.

In some examples, certain methods, machine-readable media and/or apparatus described herein may allow calibration of a set of medias by calibrating (e.g., printing and measuring) one media within the set. This may result in saving of time and media/ink waste for an end user.

In some examples, certain methods, machine-readable media and/or apparatus described herein may allow the calibration of different media types such as backlit, textiles and texturized substrates that may not otherwise be readily colorable with other approaches and/or may need dedicated sensing devices to perform calibration measurements.

In some examples, certain methods, machine-readable media and/or apparatus described herein may allow an end user to configure (e.g., add) new media to be added to a printer ecosystem that is cross-media calibrated.

In some examples, certain methods, machine-readable media and/or apparatus described herein may allow the development of printer color resources (e.g., ink-color response) without the need of measuring drop weight on every media characterization (i.e., by simply performing measurements on a first medium).

In some examples, certain methods, machine-readable media and/or apparatus described herein, during printer color resources development and at user level there may be no need to generate color references for every media as they are simulated to the relative nominal drop weight. Such an approach may yield color consistency among all the population of printers without the need to connect them somehow.

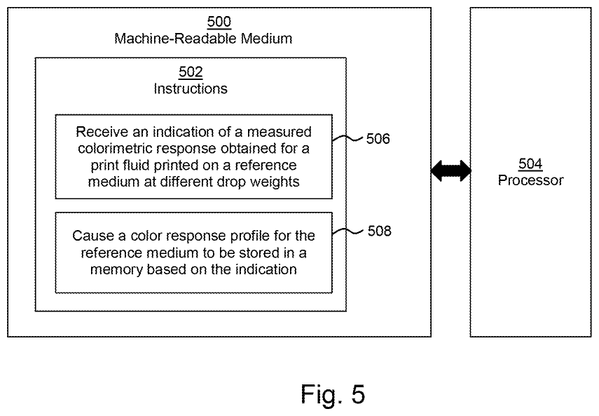

FIG. 5 shows an example tangible machine-readable medium 500 storing instructions 502 which, when executed by at least one processor 504, cause the at least one processor 504 to implement certain methods (e.g., the method 100) or processes (e.g., process 200 or 300) described herein.

The instructions 502 comprises instructions 506 to receive an indication of a measured colorimetric response obtained for a print fluid printed on a reference medium at different drop weights. In some examples, the instructions 506 are implemented as part of block 204 or 214 as depicted by the ecosystem 200.

The instructions 502 further comprises instructions 508 to cause a color response profile for the reference medium to be stored in a memory based on the indication. In some examples, the instructions 508 are implemented as part of block 208 or 218 as depicted by the ecosystem 200.

Thus, the machine-readable medium 500 may be used to cause the at least one processor to store the color response profile for the reference medium in the memory (e.g., of a user terminal or of a server or cloud-based service) as part of creation of the ecosystem 200. The color response profile for the reference medium may be used elsewhere in the processes depicted by FIGS. 2 and 3.

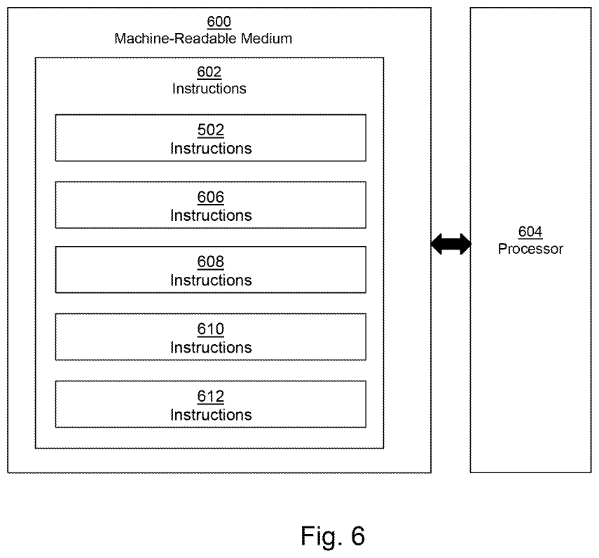

FIG. 6 shows another example tangible machine-readable medium 600 storing instructions 602 which, when executed by at least one processor 604, cause the at least one processor 604 to implement certain methods (e.g., the method 100) or processes (e.g., process 200 or 300) described herein. Where appropriate, certain instructions described in the examples below may be omitted from the machine-readable medium 600.

In some examples, the instructions 602 comprise the instructions 502 of FIG. 5.

In some examples, the instructions 602 comprise instructions 606 to cause the at least one processor 604 to receive another indication of a measured colorimetric response obtained for the print fluid printed on another medium (e.g., a first or second medium) at the same drop weights used for printing with the print fluid on the reference medium. The instructions 606 further cause the at least one processor 604 to cause a color response profile for the other medium to be stored in the memory based on the other indication. In some examples, the instructions 606 may correspond to implementing blocks 224 and/or 228 as shown in FIG. 2.

In some examples, the instructions 602 comprises instructions 608 to cause the at least one processor 604 to receive a further indication of a repeated measurement of a colorimetric response obtained for the print fluid printed on the reference medium at the different drop weights. The instructions 608 are to further cause the at least one processor 604 to compare the indication and the further indication to determine whether or not to update the color response profile for the reference medium stored in the memory. In some examples, the instructions 608 correspond to implementing blocks 214 to 218 of FIG. 2.

In some examples, the instructions 602 comprise instructions 610 to cause the at least one processor 604 to set a reference drop weight ratio for the color response profile associated with the reference medium to one (i.e., DWR=1.0). Setting the reference DWR to DWR=1 when adding a new medium to the ecosystem 200 may, in some examples, enable better color matching between printers and/or even different media without the need to export references or link the printers somehow as each printer may intrinsically point to the same nominal state.

In some examples, the instructions 602 comprise instructions 612 to cause the at least one processor 604 to cause a print element to print a color calibration pattern with the print fluid on the reference medium for each of the different drop weights. The instructions 612 further cause the at least one processor 604 to cause a sensing element (e.g., a ‘sensor’) to obtain the indication of the measured colorimetric response obtained for the print fluid printed on the reference medium at the different drop weights. In some examples, the instructions 612 correspond to implementing blocks 202 and 204 of FIG. 2.

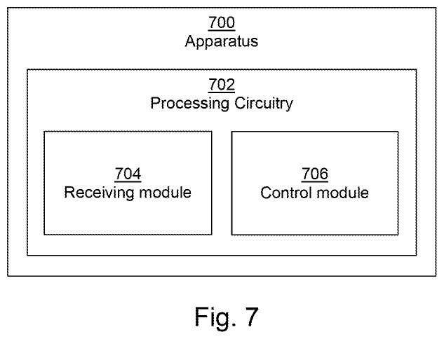

FIG. 7 shows an example apparatus 700 comprising processing circuitry 702. The processing circuitry 702 comprises a receiving module 704 and a control module 706.

In use of the apparatus 700, the receiving module 704 is to receive an estimated calibration factor (e.g., a calibration or compensation based on the DWR or DCR described above) to control a print fluid drop weight and/or number of print fluid drops to be deposited by a print element to obtain a specified color response. The estimated calibration factor may be determined from data (e.g., held in a LUT) stored in a memory.

The estimated calibration factor is based on a comparison between a color response of a print fluid printed a first medium and a color response of the print fluid printed on a reference medium at different print fluid drop weight ratios; and a pre-characterized color response of the print fluid printed on a second medium. The comparison may be implemented in blocks 316 to 320 of the process 300. As part of any of these blocks, the estimated calibration factor may be stored in the memory. The estimated calibration factor may be updated whenever repeating measurements on a color calibration pattern printed on the first medium.

In use of the apparatus 700, the control module 706 is to cause the print element to deposit the print fluid on the second medium based on the estimated calibration factor to obtain the specified color response from the print fluid deposited on the second medium. For example, an end user may have calibrated their printer previously and then they may receive the estimated calibration factor using the receiving module 704. The end user may then perform a print operation using the second medium. By virtue of the control module 706, the printer may yield a print with a specified color response. In other similar words, the apparatus 700 may enable a user to print on the second medium with the specified, or calibrated, color response.

In some examples, any of the modules described above (e.g., the receiving module 704 and/or the control module 706) may comprise at least one dedicated processor (e.g., an application specific integrated circuit (ASIC) and/or field programmable gate array (FPGA), etc) for implementing the functionality of the module.

In some examples, the module (e.g., the receiving module 704 and/or the control module 706) may comprise at least one processor for implementing instructions which cause the at least one processor to implement the functionality of the module described above. In such examples, the instructions may be stored in a machine-readable medium (not shown) accessible to the at least one processor. In some examples, the module itself comprises the machine-readable medium. In some examples, the machine-readable medium may be separate to the module itself (e.g., the at least one processor of the module may be provided in communication with the machine readable medium to access the instructions stored therein).

Further example information regarding certain procedures described above is provided below.

Certain methods, machine-readable media and/or apparatus described herein (e.g., the method 100 and other examples) may implement or be implemented via an interface (e.g., a user computer comprising the apparatus 700 and/or a computer implementing certain methods, machine-readable media and/or apparatus described herein) which may be used when an end user wishes to calibrate the printer or printhead. In some examples, the interface may be communicatively coupled to the printer such that an instruction may be sent to the printer to cause the printer to perform a print operation. In some examples, the interface may be communicatively coupled to a sensor for measuring the color response such that an instruction to cause the sensor to obtain the measurement may be initiated via the interface and/or data from the sensor may be received at or via the interface. In some examples, the interface may be communicatively coupled to a memory (e.g., of a user computer, cloud or server-based service) storing certain information (e.g., data obtained from the sensor, printer operation instructions and/or sensor operation instructions). In some examples, a computer operated by an end-user may comprise the interface and the computer may at least partially implement certain blocks of the method 100. In some examples, a computer operated by an end-user may comprise the interface, which may cause another computer (such as a cloud or server-based service) to least partially implement certain blocks of the method 100.

Whichever computer determines the color response and/or a calibration for compensating for the color response, this information may be used to calibrate the printer to achieve the specified color response. For example, print operation instructions stored on the printer and/or a look-up table (LUT) accessible to the printer may be updated so that when an interface instructs the printer to print on the medium, the correct amount of print fluid is printed on the medium in order to achieve the specified color response.

For example, the printer may use a LUT associating colors to be printed with a dot density and a drop size. Updating the print operation instructions may comprise setting or modifying entries in the look up table. The LUT may associate values in a first color space with values in a second color space. For example the first color space may be the CIELAB color space which expresses a color as three values: L* for the lightness, a* from green to red and b* from blue to yellow. In other examples the first color space may be RGB in which a color is expressed in terms of red, green and blue. The second color space may be a color space which is suitable for use in printing, such as the CMYK color space wherein a color is expressed in terms of cyan, magenta, yellow and black.

Some print apparatus comprise a plurality of printheads. Therefore in some examples the method of calibration may be performed for each printhead of the plurality of printheads in the print apparatus. In this way each printhead can print colors consistently and variation between printheads may be reduced.

In some examples, a color calibration pattern (as described in relation to certain methods described above) may be printed according to print instructions. The calibration pattern may comprise a first region comprising dots at a first dot density, a second region comprising dots at a second dot density, a third region comprising dots at a first size, a fourth region comprising dots at a second size. In this example the second dot density is greater than the first dot density and the second size is greater than the first size.

This example color calibration pattern provides regions with two different dot densities and two different dot sizes. In some examples the dot density of the first region may be the same as the dot density of either the third region or the fourth region. In other examples the dot density of the second region may be the same as the dot density of either the third region or the fourth region.

In some examples, a print apparatus may print the color calibration pattern by varying the drop size to print different sized dots and by varying dot density between the different regions, wherein the drop size and dot density are controlled in print instructions. After printing the calibration pattern, a sensor may perform a measurement on the printed calibration pattern. For example the print apparatus may comprise a sensor which may be used to measure the regions of the color calibration pattern. The sensor may measure the quantity or the color of light reflected from each region of the calibration pattern. In some examples, a color calibration pattern may be printed for each print fluid of the print apparatus (for example, a color calibration pattern may be printed in each of a Cyan, Magenta, Yellow and blacK ink of a CMYK printer, and/or the print operating instructions may be determined for each print fluid separately).

Such a color calibration pattern may be measured by a print apparatus and used in a calibration procedure. In some examples, it may be assumed that there is a substantially linear relationship between the dot density and the visual lightness or darkness of the printed color and that there is also a substantially linear relationship between the dot size and the visual lightness or darkness of the printed color. In other examples a more complex interpolation may be used to determine how print operating instructions should be set such that the printed output tends towards an intended printed output (e.g., the ‘specified color response’). In some examples, calibration patterns may be printed based on new control instructions (e.g. a different dot and/or dot density) until a printed output which meets predetermined parameters is produced.

While in this example, there are two different dot sizes and two different dot densities, in other examples more regions with different dot sizes and dot densities may be printed and measured.

In some examples measuring the magnitude of light reflected comprises measuring light reflected from each of the first region, the second region, the third region and the fourth region. The printing apparatus may then compare the measured magnitude of light returned from each region to an expected value. In one example the printing apparatus may then select the region which had a measured reflected light closest to the expected value and use the drop size and dot density parameters which were used in printing that particular region when printing that particular color in future printing operations. In other examples the printing apparatus may perform an interpolation to determine the dot density and drop size which should be used when printing a particular color based on the measured printed calibration pattern.

Features described in relation to methods, machine-readable media and apparatus described herein may modify, be combined with or otherwise implemented as part of any other methods, machine-readable media and apparatus described herein.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, any or any combination of the receiving module 704 and/or the control module 706) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving a color response profile associated with a first color calibration pattern printed on a first medium; and
determining, using processing circuitry:
a drop weight ratio associated with the first medium based on a color response profile for the first medium and a color response profile associated with a reference color calibration pattern printed on a reference medium; and
an anticipated color response profile associated with a second medium based on the drop weight ratio associated with the first medium and a pre-determined color response profile associated with the second medium.

2. The method of claim 1, where the color response profile associated with the reference medium comprises at least two color response profiles, where each color response profile corresponds to a different relative drop weight ratio for a print fluid printed on the reference medium.

3. The method of claim 2, where the different relative drop weight ratio is obtained by changing a parameter for controlling a weight of the print fluid output by a print element.

4. The method of claim 2, where the pre-determined color response profile associated with the second medium is obtained by printing with the same relative drop weight ratios used to obtain the color response profile associated with the reference medium.

5. The method of claim 1, comprising determining a compensation to apply to a print element to obtain a specified color response profile for printing on the second medium based on a comparison of the anticipated color response profile associated with the second medium and the pre-determined color response profile associated with the second medium.

6. The method of claim 5, where the compensation comprises a print fluid drop count ratio for the print element to deliver to correct for a color response of the second medium at a given number of print fluid drops to obtain the specified color response profile.

7. The method of claim 1, further comprising causing a print element to print the first color calibration pattern.

8. The method of claim 1, further comprising causing a measurement device to obtain an indication of the color response profile associated with the first color calibration pattern printed on the first medium.

9. The method of claim 1, comprising using a comparison of the color response profile associated with the first color calibration pattern printed on the first medium and the color response profile associated with the reference color calibration pattern printed on the reference medium to update a memory indicating a drop weight ratio to use for printing on each of a plurality of media to calibrate the color response profile of each of the plurality of media.

10. A tangible machine-readable medium storing instructions which, when executed by at least one processor, cause the at least one processor to:
receive an indication of a measured colorimetric response obtained for a print fluid printed on a reference medium at different drop weights; and
cause a color response profile for the reference medium to be stored in a memory based on the indication.

11. The tangible machine-readable medium of claim 10, where the instructions are to cause the at least one processor to:
receive another indication of a measured colorimetric response obtained for the print fluid printed on another medium at the same drop weights used for printing with the print fluid on the reference medium; and
cause a color response profile for the other medium to be stored in the memory based on the other indication.

12. The tangible machine-readable medium of claim 10, where the instructions are to cause the at least one processor to:
receive a further indication of a repeated measurement of a colorimetric response obtained for the print fluid printed on the reference medium at the different drop weights; and
compare the indication and the further indication to determine whether or not to update the color response profile for the reference medium stored in the memory.

13. The tangible machine-readable medium of claim 10, where the instructions are to cause the at least one processor to:
set a reference drop weight ratio for the color response profile associated with the reference medium to one.

14. The tangible machine-readable medium of claim 10, where the instructions are to cause the at least one processor to:
cause a print element to print a color calibration pattern with the print fluid on the reference medium for each of the different drop weights; and
cause a sensing element to obtain the indication of the measured colorimetric response obtained for the print fluid printed on the reference medium at the different drop weights.

15. Apparatus comprising processing circuitry, the processing circuitry comprising:
a receiving module to receive an estimated calibration factor to control a print fluid drop weight and/or number of print fluid drops to be deposited by a print element to obtain a specified color response, where the estimated calibration factor is based on:
a comparison between a color response of a print fluid printed on a first medium and a color response of the print fluid printed on a reference medium at different print fluid drop weight ratios; and
a pre-characterized color response of the print fluid printed on a second medium; and
a control module to cause the print element to deposit the print fluid on the second medium based on the estimated calibration factor to obtain the specified color response from the print fluid deposited on the second medium.
